(19) United States
(12) Patent Application Publication
(10) Pub. No.: US 2013/0049675 A1
(43) Pub. Date: Feb. 28, 2013

(54) OUTPUT CONNECTOR EQUIPPED BATTERY PACK, BATTERY-PACK-AND-BATTERY-DRIVEN-DEVICE SYSTEM, AND CHARGING METHOD BY USING BATTERY PACK

(71) Applicant: Sadao MINAMI, Awaji-shi (JP)

(72) Inventor: Sadao MINAMI, Awaji-shi (JP)

(21) Appl. No.: 13/491,923

(22) Filed: Jun. 8, 2012

(30) Foreign Application Priority Data
Aug. 30, 2011 (JP) 2011-187935

(51) Int. Cl. H02J 7/00

(52) U.S. Cl. 320/103

(57) ABSTRACT

An output connector 20 includes a power supply terminal portion 20A′ and a data terminal portion 20A″. The power supply terminal portion 20A′ can supply a current required for a battery-driven device connected to the output connector 20. The data terminal portion 20A″ can switch the terminal voltage of this data terminal portion 20A″ between different voltages based on a current which is drawn by the battery-driven device through the power supply terminal portion 20A′. A power supply control circuit can detect the current value of current which is drawn by battery-driven devices so that the battery pack can switch the data terminal portion based on the detected data between the different voltages. Therefore, even single battery pack can supply electric power to a plurality of types of battery-driven devices.

### BACKGROUND OF THE INVENTION

1. Field of the Invention

The present invention relates to a battery pack which can be suitably used as a portable power supply, and includes a rechargeable battery and an output connector for supplying electric power to an external battery-driven device connected to the output connector. The present invention also relates to a battery-pack-and-battery-driven-device system, and a charging method by using a battery pack which can be suitably used as a portable power supply, and includes a rechargeable battery and an output connector for supplying electric power to an external battery-driven device connected to the output connector.

2. Description of the Related Art

A battery pack has been developed which includes a pair of cylindrical batteries (see Japanese Patent Laid-Open Publication No. JP 2009-131,089 A). The battery pack disclosed in JP 2009-131,089 A is used as portable power supply. FIG. 12 is an exploded perspective showing this battery pack. In this battery pack, an electrically-insulating holder 903 is arranged between the pair of cylindrical batteries 901. This electrically-insulating holder 903 holds the cylindrical batteries 901 and a plated circuit 904 in place. Thus, a battery assembly 909 is constructed of the electrically-insulating holder 903, the cylindrical batteries 901, and the plated circuit 904. This battery assembly 909 is accommodated in an exterior case 902.

This battery pack includes a USB slot as output connector for supplying electric power to a battery-driven device. USB slots are a standardized connector which can provide/receive data and additionally can supply electric power, and have been widely used. Accordingly, electric power can be supplied through the USB slot to many types of mobile, battery-driven devices such as mobile phone, smart phone, slate PC (tablet terminal), portable music player, and the like which comply with the USB charging specification. As for the charging operation with USB slots, the charging current is specified by the USB charging specification. In the charging operation, the maximum charging current is limited to 500 mA, while the maximum charging voltage is limited to 5 V.

On the other hand, various types of battery-driven devices require different amounts of charging currents when charged. In recent years, so-called slate PCs become popular. In particular, slate PCs have a large screen, and consume a relatively larger amount of power. For this reason, slate PCs include a large capacity device-side rechargeable battery. The charge time correspondingly increases for charging the large capacity device-side rechargeable battery. However, it is often required to reduce the charging time. In order to satisfy this requirement, it is necessary to increase the charging current. As for a battery-driven device which can be charged with a large current, it is usually conceivable that a dedicated charger is prepared for charging this battery-driven device with a large current.

However, if dedicated chargers are separately required for various types of battery-driven device, the number of chargers to be carried by the user increases with the number of carried battery-driven devices, which in turn causes inconvenience from the viewpoint of portability. In recent years, many types of battery-driven devices include the USB slot. Accordingly, in the case where a USB charger is prepared which can charge devices through the USB slot, a plurality of devices can be charged by only single USB charger.

However, existing USB chargers cannot supply electric power over the specified electric power. The reason is that the output electric power of USB chargers is limited to the specified electric power by the USB standards as discussed above.

That is, the maximum output current and output voltage are limited to 500 mA and 5 V, respectively. Accordingly, although battery-driven devices can be charged, they cannot be quickly charged. For this reason, this limitation results in inconvenience for users.

### SUMMARY OF THE INVENTION

The present invention is aimed at solving the problem. It is a main object of the present invention to provide an output connector equipped battery pack which can charge battery-driven devices with differently specified charging currents, and to provide a battery-pack-and-battery-driven-device system and a charging method which can charge a battery-driven device by using a battery pack.

To achieve the above object, a battery pack according to a first aspect of the present invention includes an output connector 20, a rechargeable battery cell 11, and a power supply control circuit 12. The power supply control circuit 12 converts a voltage from the rechargeable battery cell 11 into an output voltage. The output connector can be connected to a battery-driven device, and supply the electric power to a device-side rechargeable battery included in the battery-driven device. The output voltage converted by the power supply control circuit 12 can be provided to the external battery-driven device through the output connector 20. The output connector 20 includes a power supply terminal portion 20A′ and a data terminal portion 20A″. Current required for the battery-driven device connected to the output connector 20 can be supplied through the power supply terminal portion 20k. A terminal voltage on the data terminal portion 20A″ can be switched between different voltages based on a current which is drawn by the battery-driven device through the power supply terminal portion 20A′. According to this construction, the power supply control circuit can detect the current value of a current which is drawn by a battery-driven device so that the battery pack can switch the data terminal portion based on the detected data between the different voltages. Therefore, even one battery pack can suitably supply electric power to a plurality types of battery-driven devices.

In a battery pack according to a second aspect of the present invention, the power supply control circuit 12 can select from among terminal voltage selection modes for setting a terminal voltage on the data terminal portion 20A″ based on the charging current. The terminal voltage selection modes include an intermediate voltage mode, and a short circuit mode. In the intermediate voltage mode, predetermined voltages are applied to D+ and D− terminals 20c and 20d as the data terminal portion. In the short circuit mode, the D+ and D− terminals 20c and 20d are short-circuited. According to this construction, since the data terminal portion of the battery pack can be switched between two modes, it is possible to suitably select from the two modes when the battery pack charges a battery-driven device which is connected to the battery pack.

In a battery pack according to a third aspect of the present invention, the terminal voltage selection modes of the power supply control circuit 12 can further include a non-monitoring mode in which electric power is supplied to the battery-driven device without monitoring a voltage on the data terminal portion 20A″. According to this construction, the battery pack can charge even a battery-driven device which does not monitor the data terminal portion.

In a battery pack according to a fourth aspect of the present invention, the intermediate voltage mode can be a terminal voltage selection mode for slate PC, and the short circuit mode can be a terminal voltage selection mode for smart phone. According to this construction, it is possible to determine whether a battery-driven device connected to the battery pack requires large electric power.

In a battery pack according to a fifth aspect of the present invention, in the intermediate voltage mode, the power supply control circuit 12 can hold the intermediate voltage mode and select a first current mode if the charging current drawn by the battery-driven device is not lower than a predetermined first threshold current. In the first current mode, the charging current drawn through the power supply terminal portion 20A′ is limited to a predetermined first upper limit current value. In the intermediate voltage mode, the power supply control circuit 12 can switch a voltage on the data terminal portion 20A″ from the intermediate voltage mode to the short circuit mode if the detected charging current is kept lower than the first threshold current value for a predetermined time period. According to this construction, the battery pack first determines whether a battery-driven device connected to the battery pack requires a large charging current, and automatically switches a voltage on the data terminal portion from the intermediate voltage mode to the short circuit mode if the drawn current is not detected. Therefore, it is possible to suitably supply a charging current depending on the type of the battery-driven device connected to the battery pack.

In a battery pack according to a sixth aspect of the present invention, in the short circuit mode, the power supply control circuit 12 can hold the short circuit mode and select a second current mode if the charging current drawn by the battery-driven device is not lower than a predetermined second threshold current. In the second current mode, the charging current drawn through the power supply terminal portion 20A′ is limited to a predetermined second upper limit current value smaller than the predetermined first upper limit current value. In the short circuit mode, the power supply control circuit 12 can switch from the short circuit mode to the non-monitoring mode and select a third current mode if the detected charging current is kept lower than the second threshold current value for a predetermined time period. In the third current mode, the charging current drawn through the power supply terminal portion 20A′ is limited to a predetermined third upper limit current value smaller than the predetermined second upper limit current value. According to this construction, since the charging current is limited based on the current value of current which is drawn by a battery-driven device connected to the battery pack, it is possible to more suitably supply a charging current required for the battery-driven device connected to the battery pack.

In a battery pack according to a seventh aspect of the present invention, in the first or second current mode, the power supply control circuit 12 can stop supplying electric power through the power supply terminal portion 20A′ if the charging current is kept lower than a predetermined third threshold current lower than the first and second threshold currents for a predetermined time period. According to this construction, the battery pack can stop charging a battery-driven device connected to the battery pack based on the charging current depending on the type of the battery-driven device connected to the battery pack. This battery pack can charge slate PCs in the first current mode, and can charge smart phones in the second current mode, for example.

In a battery pack according to an eighth aspect of the present invention, in the third current mode, the power supply control circuit 12 can stop supplying electric power through the power supply terminal portion 20A′ if the charging current is kept lower than a fourth predetermined threshold current lower than the third threshold current for a predetermined time period. According to this construction, even in the case of a low capacitive load driving mobile device which includes a device-side rechargeable battery having low capacity, it is possible surely fully charge the battery and to stop supplying electric power after charging the battery in the third current mode.

In a battery pack according to a ninth aspect of the present invention, the output connector 20 can have the same terminal shape as the USB standards. According to this construction, the battery pack can supply electric power to various types of battery-driven devices which include a widely used USB slot, and can adjust the output current to the electric power corresponding to the battery-driven devices. Therefore, electric power can be supplied to a plurality of battery-driven devices by this single battery pack.

In a battery pack according to a tenth aspect of the present invention, the battery pack 10 or 30 can serve as a portable power supply device. According to this construction, the battery pack can serve as a standby power supply device which can supply electric power to various types of battery-driven devices in a case where commercial power and the like are not available.

A battery pack according to an eleventh aspect of the present invention can further include an energized coil 31, and a charge control circuit 36. The energized coil 31 can receive electric power from an energizing coil 101 when the battery pack is placed on a charging base 100. The charging base 100 includes the energizing coil 101 for transmitting the electric power by electromagnetic induction whereby charging the rechargeable battery cell. The charge control circuit 36 charges the rechargeable battery cell 11 with the electric power which is induced in the energized coil 31. The rechargeable battery cell 11 can be charged with the electric power which is induced in the energized coil 31 by the energizing coil 101 when the battery pack is placed on a charging base 100. According to this construction, the rechargeable battery cell included in the battery pack can be charged in a non-contact charging manner. As a result, mechanically connecting structures can be omitted which mechanically connects the battery pack to an electric power supplying device. Therefore, this battery pack can be conveniently used.

A battery-pack-and-battery-driven-device system according to a twelfth aspect of the present invention includes a battery-driven device, and a battery pack. The battery pack can be connected to the battery-driven device and can supply electric power to the battery-driven device. The battery-driven device includes a device-side rechargeable battery, an input connector, and a device charge control circuit. The electric power supply can be supplied through the input connector. The device charge control circuit determines whether the battery pack can supply electric power to the device-side rechargeable battery whereby charging the device-side rechargeable battery after the battery pack is connected to the input connector. The device charge control circuit controls the electric power, which is supplied from this battery pack, whereby charging the device-side rechargeable battery if determining that the battery pack can supply electric power. The battery pack includes a rechargeable battery cell 11, a power supply control circuit 12, and an output connector 20. The power supply control adjusts electric power depending on the battery-driven device. The adjusted electric power is supplied through the output connector 20. The output connector 20 includes a power supply terminal portion 20A′ and a data terminal portion 20A″. The power supply control circuit 12 can change a voltage on the data terminal portion 20A″ to different voltages. The power supply control circuit 12 has a plurality of terminal voltage selection modes which correspond to the different voltages for the data terminal portion 20A″. The power supply control circuit 12 selects from among the terminal voltage selection modes based on the charging current which is drawn by the battery-driven device, which is connected through the input connector to the output connector 20. According to this construction, since a plurality of terminal voltage selection modes are provided, different types of battery-driven devices can be charged by a single battery pack. Also, the battery pack serves as a power supply device for supplying electric power to a battery-driven device, and can select a terminal voltage selection mode in which this battery-driven device can be supplied with electric power. As a result, the battery pack can supply power supply to various types of battery-driven devices. Therefore, users can charge a battery-driven device connected to the battery pack without inconvenient operation such as switching operation for selecting a mode corresponding to the types of the battery-driven device connected to the battery pack.

A charging method according to a thirteenth aspect of the present invention is a method for charging a rechargeable battery in a battery-driven device by using a battery pack including the following steps. The battery-driven device is connected to an output connector 20 of the battery pack. The battery-driven device starts drawing current required for the battery-driven device from a rechargeable battery cell 11 included in the battery pack through a power supply terminal portion 20A′ included in the output connector 20. This current is detected by a power supply control circuit 12 included in the battery pack. The voltage of a data terminal portion 20A″ included in the output connector 20 is switched between predetermined voltages by the power supply control circuit 12 based on the value of the current, which is detected by the power supply control circuit 12, by referring a predetermined relationship between current value and terminal voltage.

In a charging method according to a fourteenth aspect of the present invention for charging a device-side rechargeable battery by using a battery pack, the data terminal portion 20A″ can include D+ and D− terminals 20c and 20d. In the relationship between current value and terminal voltage, the power supply control circuit 12 sets the D+ and D− terminals 20c and 20d to predetermined voltages if the detected current is not smaller than a first threshold current value, while the power supply control circuit 12 short-circuits the D+ and D− terminals 20c and 20d if the detected current is smaller than the first threshold current value. According to this construction, the battery pack can automatically select a suitable voltage on the data terminal portion depending on operation of the battery-driven device which detects a voltage on the data terminal portion. Therefore, the battery pack can adjust charging current to different charging currents corresponding to different types of battery-driven devices.

In a charging method according to a fifteenth aspect of the present invention for charging a device-side rechargeable battery by using a battery pack, the power supply control circuit 12 selects from among modes for setting a terminal voltage on the data terminal portion 20A″ based on the current value. The modes include an intermediate voltage mode and a short circuit mode. In the intermediate voltage mode, predetermined voltages are applied to the D+ and D− terminals 20c and 20d as the data terminal portion. In the short circuit mode, the D+ and D− terminals 20c and 20d are short-circuited.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view showing a battery pack according to a first embodiment and a slate PC, which are prepared to be connected to each other;

FIG. 2 is a perspective view showing a battery pack according to the first embodiment and a smart phone, which are prepared to be connected to each other;

FIG. 3 is a perspective view showing a battery pack according to the first embodiment and another battery-driven device, which are prepared to be connected to each other;

FIG. 4 is a determination flowchart of the battery pack according to the first embodiment for supplying electric power to battery-driven devices in the case where the battery pack determines the type of a device connected to the battery pack;

FIG. 5 is a block diagram showing the battery pack according to the first embodiment;

FIG. 6 is a perspective view showing the external shape of the battery pack according to the first embodiment as viewed from an output connector side;

FIG. 7 is a perspective view showing the external shape of the battery pack according to the first embodiment as viewed from a power receiving connector portion side;

FIG. 8 is an exploded perspective view of the battery pack according to the first embodiment;

FIG. 9 is a block diagram showing the battery pack according to a second embodiment;

FIG. 10 is a perspective view showing the battery pack according to the second embodiment placed onto a non-contact charger;

FIG. 11 is an exploded perspective view of the battery pack according to the second embodiment; and

FIG. 12 is an exploded perspective view showing a known battery pack.

### DETAILED DESCRIPTION OF THE EMBODIMENT(S)

The following description will describe embodiments according to the present invention with reference to the drawings. It should be appreciated, however, that the embodiments described below are illustrations of an output connector equipped battery pack, a battery-pack-and-battery-driven-device system, and a charging method to give a concrete form to technical ideas of the invention, and an output connector equipped battery pack, a battery-pack-and-battery-driven-device system, and a charging method of the invention are not specifically limited to description below. In this specification, reference signs corresponding to components illustrated in the embodiments are added in “Claims” and “Summary” to aid understanding of claims. Furthermore, it should be appreciated that the members shown in claims attached hereto are not specifically limited to members in the embodiments. Unless otherwise specified, any dimensions, materials, shapes and relative arrangements of the parts described in the embodiments are given as an example and not as a limitation. Additionally, the sizes and the positional relationships of the members in each of drawings are occasionally shown larger exaggeratingly for ease of explanation. Members same as or similar to those of this invention are attached with the same designation and the same reference signs, and their description is omitted. In addition, a plurality of structural elements of the present invention may be configured as a single part that serves the purpose of a plurality of elements, on the other hand, a single structural element may be configured as a plurality of parts that serve the purpose of a single element. Also, the description of some of examples or embodiments may be applied to other examples, embodiments or the like.

### First Embodiment

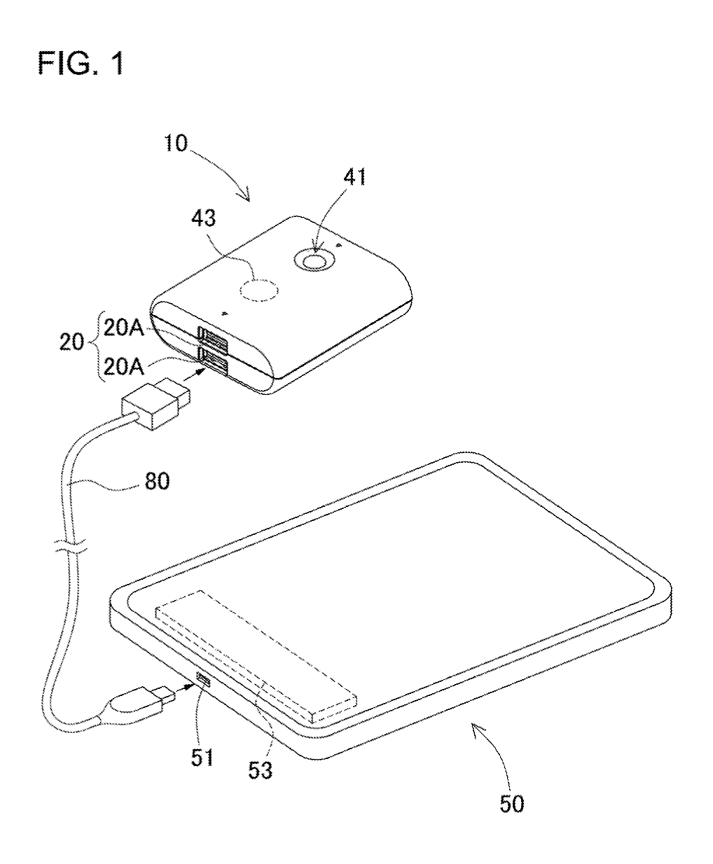

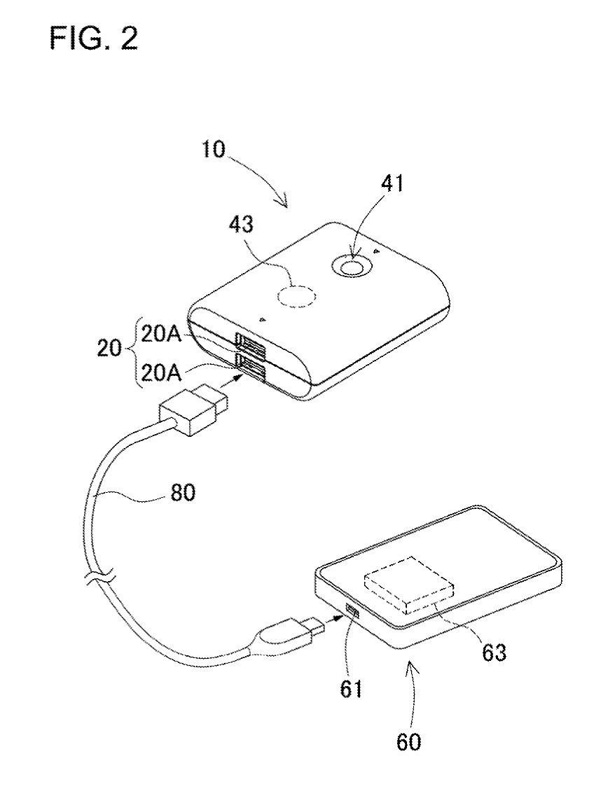

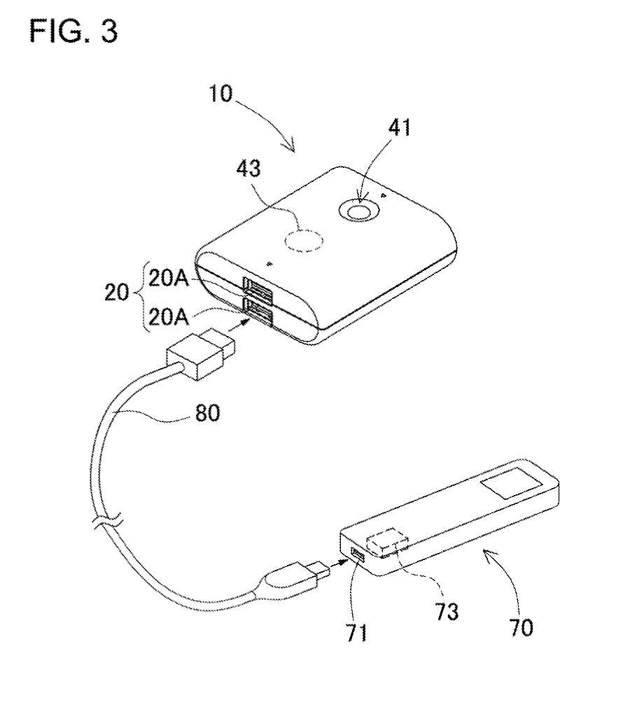

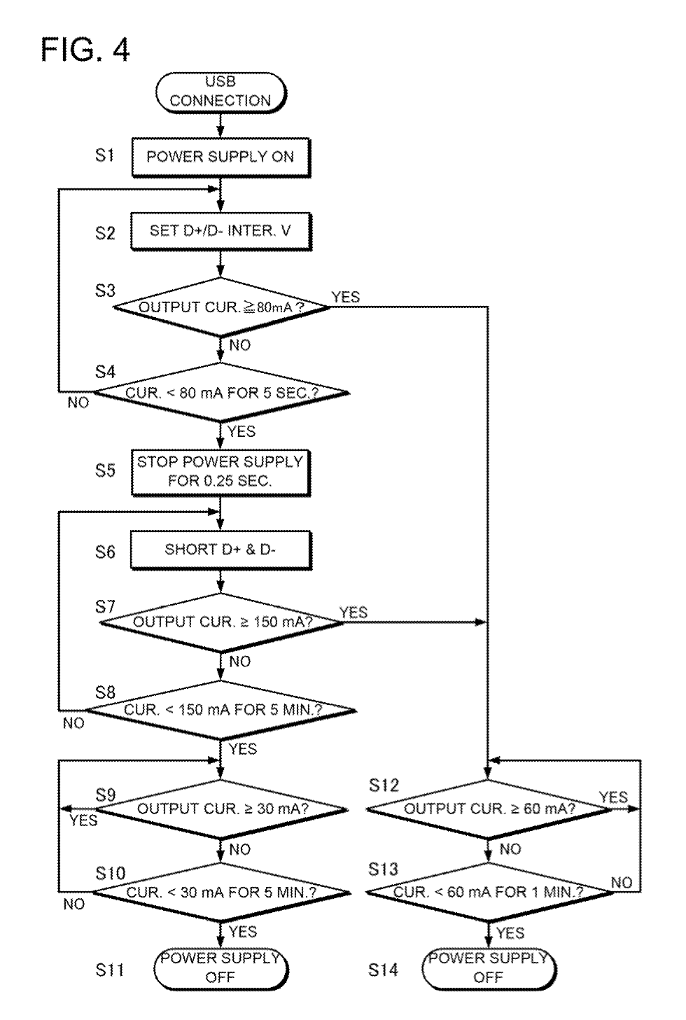

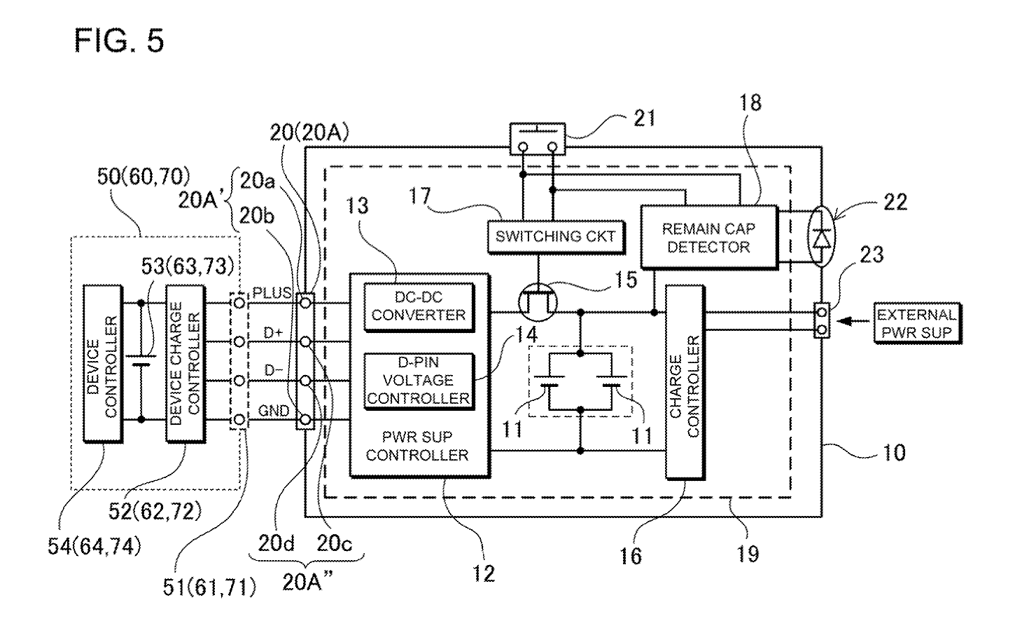

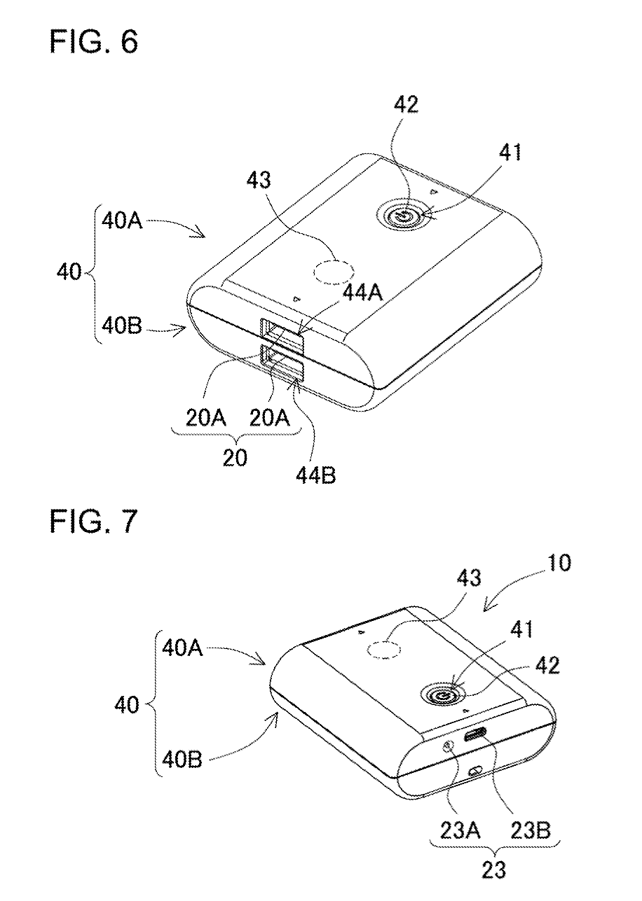

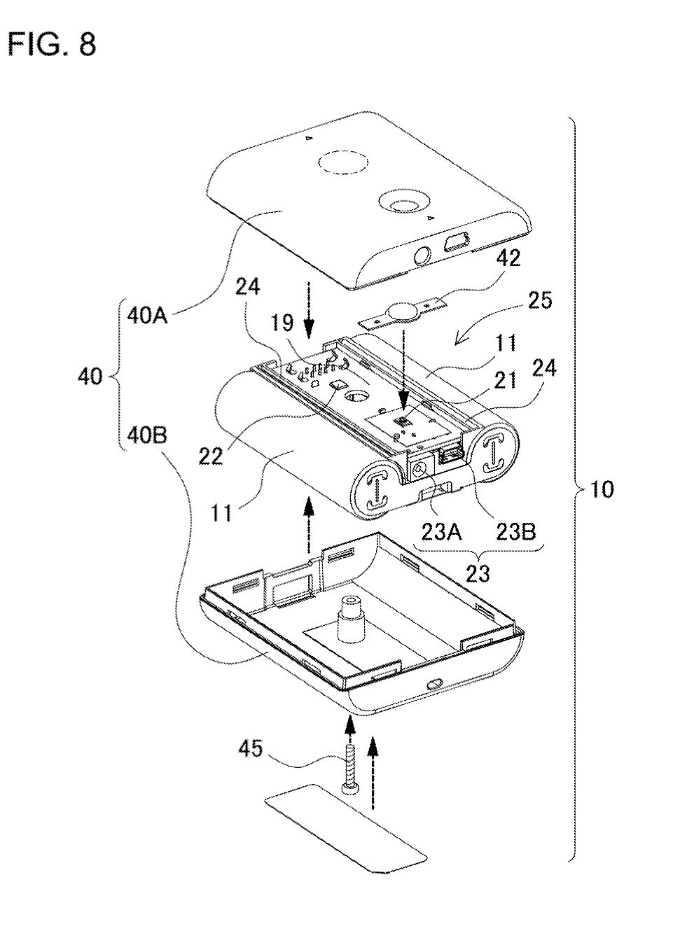

The following description will describe a battery pack according to a first embodiment which can supply electric power to a battery-driven device with reference to FIGS. 1 to 8. FIG. 1 is a perspective view showing the battery pack and a slate PC, which are prepared to be connected to each other. FIG. 2 is a perspective view showing the battery pack and a smart phone PC, which are prepared to be connected to each other. FIG. 3 is a perspective view showing the battery pack and another battery-driven device, which are prepared to be connected to each other. FIG. 4 is a determination flowchart of the battery pack for supplying electric power battery-driven devices in the case where the battery pack determines the type of a device connected to the battery pack. FIG. 5 is a block diagram showing the battery pack according to the first embodiment. FIG. 6 is a perspective view showing the external shape of the battery pack according to the first embodiment as viewed from an output connector side. FIG. 7 is a perspective view showing the external shape of the battery pack according to the first embodiment as viewed from a power receiving connector portion side. FIG. 8 is an exploded perspective view of the battery pack according to the first embodiment.

FIGS. 1 to 3 show the battery pack and battery-driven devices, which are prepared to be connected to each other. The battery-driven devices include an input connector through which electric power is supplied. As for electric power supply, battery-driven devices are conventionally charged through AC/DC adapters, or the like. However, recently, battery-driven devices are becoming popular which can be supplied with electric power supply, and can additionally transmit/receive data through USB slots. However, the different charging currents and different charging voltages are required depending on types of battery-driven devices which can be supplied with electric power through USB slots. For this reason, power supply devices are required depending on types of battery-driven devices. To solve this problem, the battery pack according to the first embodiment is a portable battery pack which can supply electric power to the battery-driven device through a USB slot and is not limited to a particular type of battery-driven device.

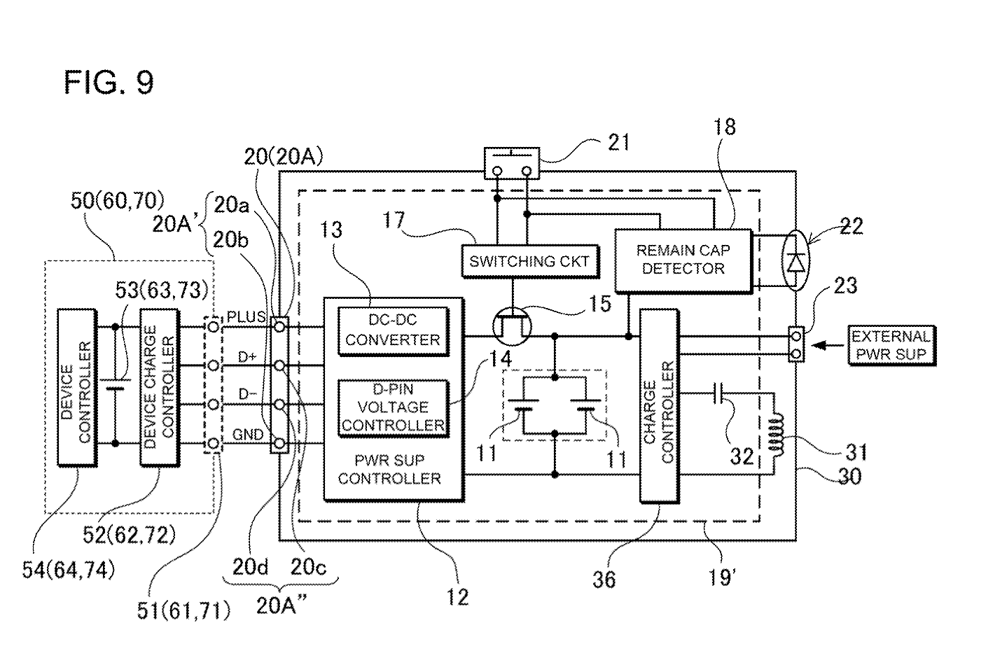

The battery-driven device 50 shown in FIG. 1 is a slate PC which includes a large liquid crystal panel. Slate PCs are also referred to as tablet PC, or the like. The slate PC includes a large device-side rechargeable battery 53. Correspondingly, as for power supply, large electric power is required for charging the large device-side rechargeable battery 53. The battery pack 10 includes output connectors 20 of USB slots 20A. Electric power can be supplied through the USB slot 20A. In addition, data can be transmitted/received through the USB slot 20A. A USB connector cable 80 can be connected to the USB slot 20A, and can be connected to a USB input slot 51 which serves as an input connector of the battery-driven device 50. Thus, electric power can be supplied through the USB connector cable 80 to the battery-driven device 50. The battery pack 10 includes a rechargeable battery cell. The battery pack 10 can include a non-contact charging circuit for charging the rechargeable battery cell. This type of exemplary battery pack is shown as a battery pack 30 according to a second embodiment in FIGS. 9 to 11, and will be described later. This battery pack 30 can supply electric power to the battery-driven device similar to the battery pack 10. From this viewpoint, the battery pack 30 can be used instead of the following battery pack 10.

The battery-driven device 50 as slate PC monitors a later-discussed data terminal portion 20A″ of the USB slot 20A, and determines whether a power supply device connected to the battery-driven device 50 can supply electric power required for the battery-driven device 50. This battery pack 10 can serve as power supply device for the battery-driven device 50 as slate PC based on control through the data terminal portion 20A″ of the USB slot. If the battery-driven device 50 determines that a power supply device connected to the battery-driven device 50 cannot supply electric power required for the battery-driven device 50, the charging operation is not performed. In this case, the battery pack 10 stops supplying electric power for a predetermined time period.

The battery-driven device 60 shown in FIG. 2 is a mobile phone, a smart phone, or the like. Similar to the battery-driven device 50 as slate PC, the battery-driven device 60 monitors the data terminal portion 20A″ of the USB slot 20A, and determines whether a power supply device connected to the battery-driven device 60 can supply electric power required for the battery-driven device 60. Some battery-driven devices have a quick charge mode in which their batteries can be quickly charged. The battery pack according to this embodiment can supply electric power required for the quick charge available battery-driven devices based on the control through the data terminal portion of the USB slot. The battery-driven device 60 includes a device-side rechargeable battery 63 as driving battery for driving this battery-driven device 60.

Electric power is supplied to the device-side rechargeable battery 63 of the battery-driven device 60 through the USB slot 20A from the battery pack 10 as power supply device. Specifically, one end of the USB connector cable 80 is connected to the USB slot 20A of the battery pack 10, while the other end is connected to a USB input slot 61 as input connector included in the battery-driven device 60. Thus, the device-side rechargeable battery 63 can be charged.

The battery-driven device 70 shown in FIG. 3 is a low capacitive load driving mobile device such as portable music player and portable recorder, which includes a device-side rechargeable battery 73 having low capacity. Among low capacitive load driving mobile devices corresponding to the battery-driven device 70, some types of low capacitive load driving mobile devices do not monitor the data terminal portion 20A″ of the USB slot 20A. Also, some types of low capacitive load driving mobile devices do not require large electric power. The battery pack 10 according to this embodiment can charge such a low capacitive load driving mobile device as the battery-driven device 70 with small or large electric power. Accordingly, the battery pack 10 can surely fully charge the low capacitive load driving mobile device.

Electric power is similarly supplied to the device-side rechargeable battery 73 of the battery-driven device 70 through the USB slot 20A from the battery pack 10. Specifically, one end of the USB connector cable 80 is connected to the USB slot 20A of the battery pack 10, while the other end is connected to a USB input slot 71 as input connector included in the battery-driven device 70. Thus, the device-side rechargeable battery 73 can be charged.

### (First Current Mode)

As discussed above, the single battery pack according to this embodiment can charge a plurality of types of battery-driven devices such as slate PC, and smart phone or low capacitive load driving mobile device which are charged with different charging currents. The following description will describe this charging operation with reference to the flowchart of FIG. 4.

In Step S1, after being connected to a battery-driven device, the battery pack 10 starts supplying electric power to the battery-driven device. The USB slot 20A of the battery pack 10 includes a later-discussed power supply terminal portion 20A′ and the data terminal portion 20A″. The data terminal portion 20A″ includes D+ and D− terminal (pins) 20c and 20d. Different voltages can be applied to these terminals. The voltages to be applied to the D+ and D− terminal 20c and 20d can be selected from the different voltages. A plurality of combinations are previously prepared. Each of plurality of combinations includes different voltages. One combination can be selected from among the plurality of combinations as terminal voltage selection modes. One of the terminal voltage selection modes can be selected based on the charging current which is drawn by the battery-driven device.

In Step S2, an intermediate voltage mode is first selected from the terminal voltage selection modes. In the intermediate voltage mode, predetermined voltages are applied to the D+ and D− terminals 20c and 20d. In this embodiment, these predetermined voltages as intermediate voltages can be voltages which are fractions of the output voltage of a 5V power supply, for example. The intermediate voltage mode is a tablet PC mode suitable for rated voltage of tablet PCs.

In the case where the battery-driven device 50 is a battery-driven device which detects the intermediate voltages such as slate PC, the battery-driven device 50 will detect voltages (intermediate voltages) on the D+ and D− terminals 20c and 20d, and determine whether a power supply device connected to the battery-driven device 50 can supply electric power required for the battery-driven device 50. If determining that this power supply device can supply the required electric power, the battery-driven device 50 starts charging the device-side rechargeable battery. If the battery-driven device 50 does not determine that this power supply device can supply the required electric power, the battery-driven device 50 restricts the charging operation, or stops charging the device-side rechargeable battery.

In Step S3, the battery pack 10 detects the output current by using a later-discussed DC-DC converter 13, and determines whether the output current at the start of detection is at least a first threshold current value (e.g., 80 mA). If YES in Step S3 (in other words, if it is determined that the output current at the start of detection is not smaller than the first threshold current value), the procedure goes to Step S12. In the case where a battery-driven device connected to the battery pack is a slate PC as the battery-driven device 50 which includes the device-side rechargeable battery, and draws a charging current up to the maximum charging current value which is specified in the first current mode, or in the case where a battery-driven device connected to the battery pack is a device which does not monitor the data terminal portion 20A″, the device-side rechargeable battery is charged with the drawn charging current. In this case, in the first current mode, when a current is required (drawn) by the battery-driven device 50 of slate PC or a device which does not monitor the data terminal portion 20A″, the battery pack 10 can limit the maximum amount of this required current to 1 or 1.5 A. It is noted that the aforementioned first threshold current value is not limited to 80 mA, but can be a current value suitable for specifications of battery-driven devices.

If the output current at the start of detection is smaller than 80 mA (If NO in Step S3), the procedure of the battery pack 10 goes to Step S4. If the device-side rechargeable battery of the battery-driven device 50 of slate PC is nearly fully charged, the procedure goes to Step S4. If a battery-driven device connected to the battery pack is a type of device (e.g., smart phone) which does not detect the intermediate voltages, and starts charging the device-side rechargeable battery when detecting short circuit between the D+ and D− terminals 20c and 20d, the procedure also goes to Step S4. If the device-side rechargeable battery of a device which does not monitor the data terminal portion 20A″ is nearly fully charged, the procedure also goes to Step S4. In Step S4, it is determined whether the output current of the DC-DC converter 13 is kept smaller than 80 mA for about five seconds. If YES in Step S4, the procedure goes to Step S5. If 80 mA or more of output current is detected within this time period (about five seconds), in other words, if NO in Step S4, the procedure returns to Step S2. After that, the output current is detected again. In these steps, even if the output current is small, the device-side rechargeable battery is kept charged for a certain time period. The reason is that the charging current will not reach a sufficient charging current at the start of charging operation in some cases.

### (Second Current Mode)

In Step S5, the battery pack 10 stops supplying electric power output for about 0.25 second. Subsequently, the procedure goes to Step S6. In Step S6, a power supply control circuit 12 short-circuits the D+ and D− terminals 20c and 20d, which are the data pins 20A″ of the battery pack 10. Accordingly, the battery pack 10 can recognize that a battery-driven device connected to the battery pack 10 is the battery-driven devices 60 such as smart phone which monitors the data terminal portion 20A″ and can recognize the short circuit status, or another battery-driven device which does not monitor the data terminal portion 20A″. Both the terminals re short-circuited when a Smart Phone mode specification is selected from the terminal voltage selection modes. On the other hand, if the device-side rechargeable battery of the battery-driven device 50 of slate PC is nearly fully charged, the battery-driven device 50 cannot detect intermediate voltages at the data terminal portion 20A″, and stops charging the device-side rechargeable battery.

Subsequently, the procedure goes to Step S7. In Step S7, the battery pack 10 detects the output current by using the DC-DC converter 13, and determines whether the output current at the start of detection is at least a second threshold current value of 150 mA. If YES in Step S7 (in other words, if it is determined that the output current at the start of detection is not smaller than the second threshold current value), the procedure goes to Step S12. In the case where a battery-driven device connected to the battery pack is the battery-driven device 60 such as smart phone which includes the device-side rechargeable battery, and draws a charging current up to the maximum charging current value which is specified in the second current mode, the device-side rechargeable battery is charged with the drawn charging current. On the other hand, in the case where a battery-driven device connected to the battery pack is another battery-driven device which does not monitor the data terminal portion 20A″, the device-side rechargeable battery can be charged with a drawn charging current even if the drawn charging current is not smaller than 150 mA. In this case, in the second current mode, when a current is required by the battery-driven device 60 of smart phone or another device which does not monitor the data terminal portion 20A″, the battery pack 10 can limit the maximum amount of this required current to 1 A. If the output current at the start of detection is smaller than 150 mA (if NO in Step S7), the battery pack 10 determines that the device-side rechargeable battery of the battery-driven device 60 of smart phone is nearly fully charged, or that the device-side rechargeable battery of a battery-driven device which does not monitor the data terminal portion 20A″ is nearly fully charged. The procedure goes to Step S8. It is noted that the aforementioned second threshold current value is not limited to 150 mA, but can be a current value suitable for specifications of battery-driven devices.

### (Third Current Mode)

In Step S8, it is determined whether the output current of the DC-DC converter 13 is kept smaller than 150 mA for about five minutes. If YES in Step S8, the procedure goes to Step S9. If 150 mA or more of output current is detected within this time period (about five minutes), in other words, if NO in Step S8, the procedure returns to Step S6. In these steps, even if the output current is small, the device-side rechargeable battery is kept charged for a certain time period. The reason is that the charging current will not reach a sufficient charging current at the start of charging operation in some cases.

In Step S9, the battery pack 10 can keep charging the device-side rechargeable battery of the battery-driven device 60 of smart phone or another battery-driven device which is nearly fully charged. Here, the another battery-driven device does not monitor the data terminal portion 20A″. In this case, in a third current mode, when a current is required by the battery-driven device 70 as a low capacity load battery driven device which includes a device-side rechargeable battery having low capacity, the battery pack 10 can limit the maximum amount of this required current to a limited current corresponding to the third current mode. In addition, the battery pack 10 may have a non-monitoring mode in which, if a battery-driven device connected to the battery pack 10 does not monitor the data terminal portion 20A″, the battery pack 10 charges the device-side rechargeable battery of this battery-driven device in a non-monitoring mode manner. If the output current supplied to the battery-driven device is at least 30 mA, which is a fourth threshold current value, (in other words, if YES in Step S9), the battery pack keeps charging the device-side rechargeable battery of this battery-driven device. If the charging current is smaller than 30 mA (If NO in Step S9), the procedure goes to Step S10. It is noted that the aforementioned fourth threshold current value is not limited to 30 mA, but can be a current value suitable for specifications of battery-driven devices.

In Step S10, it is determined whether the output current of the battery pack 10 is kept smaller than 30 mA for about five minutes. If YES in Step S10, the procedure goes to Step S11. If 30 mA or more of output current is detected within this time period (about five minutes), in other words, if NO in Step S10, the procedure returns to Step S9, the battery pack keeps charging the device-side rechargeable battery.

In Step S11, the battery pack 10 determines that the device-side rechargeable battery is fully charged, and stops supplying electric power. Thus, the battery pack can surely fully charge the device-side rechargeable battery which is nearly fully charged in the battery-driven device 60 of smart phone, another battery-driven device or the battery-driven device 70 as low capacity load battery driven device. Here, the another battery-driven device does not monitor the data terminal portion 20A″. After fully charging the device-side rechargeable battery, the battery pack can surely stop supplying the current so that the device-side rechargeable battery can be prevented from being over-charged.

### (First or Second Current Mode)

In the case where the procedure goes to Step S12, the battery pack 10 recognizes that the battery pack 10 is connected to the battery-driven device 50 of slate PC, the battery-driven device 60 of smart phone, or another battery-driven device which does not monitor the data terminal portion 20A″. If the output current supplied to the battery-driven device is at least 60 mA, which is a third threshold current value, (in other words, if YES in Step S12), the battery pack keeps charging the device-side rechargeable battery of this battery-driven device. If the charging current is smaller than 60 mA (If NO in Step S12), the procedure goes to Step S13. It is noted that the aforementioned third threshold current value is not limited to 60 mA, but can be a current value suitable for specifications of battery-driven devices.

In Step S13, it is determined whether the output current of the battery pack 10 is kept smaller than 60 mA for about one minute. If YES in Step S13, the procedure goes to Step S14. If an output current of 60 mA or more is detected within this time period (about one minute), in other words, if NO in Step S13, the procedure returns to Step S12, the battery pack keeps charging the device-side rechargeable battery.

In Step S14, the battery pack 10 determines that the device-side rechargeable battery is fully charged, and stops supplying electric power. Thus, the battery pack can surely fully charge the device-side rechargeable battery of the battery-driven device 50 of slate PC, the battery-driven device 60 of smart phone, or another battery-driven device which does not monitor the data terminal portion 20A″. After fully charging the device-side rechargeable battery, the battery pack can surely stop supplying the current so that the device-side rechargeable battery can be prevented from being over-charged.

As discussed above, the battery pack 10 according to this embodiment determines which type of battery-driven device is connected to the battery pack 10 among from the battery-driven device 50 of slate PC, the battery-driven device 60 such as smart phone, and another battery-driven device which does not monitor the data terminal portions 20A″ based on the comparison of the output current value, which flows in the DC-DC converter 13, with the determination criteria. In addition, the battery pack 10 can stop supplying electric power if determining that the device-side rechargeable battery becomes fully charged. Thus, the device-side rechargeable battery of the battery-driven device can be stably supplied with charging current without being brought into an over-charged state. Therefore, it is possible to ensure the safety of the battery-driven device.

FIG. 5 is the block diagram showing the circuitry of the battery pack according to the first embodiment, and the battery-driven device 50, 60 or 70, which are connected to each other. The USB slot 20A of this battery pack 10 is connected to the USB input slot 51, 61 or 71 as input connector of the battery-driven device 50, 60 or 70.

### (Battery-Driven Device)

The battery-driven device 50, 60 or 70 to be connected to the battery pack includes a device control circuit 54, 64 or 74, and the device-side rechargeable battery 53, 63 or 73 for driving this device. When the device-side rechargeable battery 53, 63 or 73 is charged, electric power is supplied through the USB input slot 51, 61 or 71 for connecting the battery-driven device to external power supplies, and is then controlled by the device charge control circuits 52, 62 or 72 for charging the device-side rechargeable battery 53, 63 or 73. The battery-driven device 50, 60 or 70 can be connected to the battery pack 10 according to the first embodiment, which serves as a portable power supply device for supplying electric power supply.

### (Battery Pack 10)

The battery pack 10 includes the output connectors 20, a press-button switch 21, an LED 22, and a power receiving connector portion 23, which are externally exposed. Furthermore, the battery pack 10 includes a circuit board 19 on which the power supply control circuit 12, a switch 15, a switching circuit 17, a remaining capacity detecting circuit 18, and a charge control circuit 16 are integrally installed. The battery pack 10 includes rechargeable battery cells 11 as electric power source.

### (Power Supply Control Circuit 12)

The battery pack 10 according to the first embodiment includes the power supply control circuit 12, which controls electric power supplied to the battery-driven device. The power supply control circuit 12 includes the DC-DC converter 13 and a D terminal voltage control portion 14 which serve as a mode selecting portion. The D terminal voltage control portion 14 controls voltages on the terminals of the data terminal portion 20A″ discussed later so that electric power can be supplied to various types of battery-driven devices.

### (USB Slot 20A)

The output of the power supply control circuit 12 can be supplied as electric power to the battery-driven device through the output connector 20. The USB slot 20A serves as the output connector 20. The USB slot 20A includes the power supply terminal portion 20A′ and the data terminal portion 20A″. The power supply terminal portion 20A′ includes PLUS and GND terminals (pins) 20a and 20b. The data terminal portion 20A″ includes the D+ and D− terminals 20c and 20d.

### (DC-DC Converter 13)

The power supply terminal portion 20A′ receives electric power from the DC-DC converter 13 in the battery pack 10 so that electric power can be supplied which is required for the battery-driven device 50, 60 or 70. Accordingly, the battery pack 10 can supply electric power corresponding to any type of battery-driven device which includes the USB input connector without limitation on battery-driven device type.

As shown by the flowchart, when supplying electric power to the battery-driven device, the DC-DC converter 13 detects the value of a charging current which is drawn by the battery-driven device 50, 60 or 70. Thus, the battery pack 10 determines which type of battery-driven device is connected to the battery pack 10 among from slate PC, smart phone, and low capacitive load driving mobile device, and can supply a current required for the connected battery-driven device.

### (D Terminal Voltage Control Portion 14)

The D terminal voltage control portion 14 according to the first embodiment controls terminal voltages on the D+ and D− terminals 20c and 20d of the data terminal portion 20A″. The terminal voltages of on data terminal portion 20A″ are changed depending on the charging current value which is drawn by the battery-driven device through the power supply terminal portion 20A′. The DC-DC converter 13 of the battery pack 10 detects the charging current drawn by the battery-driven device. Initially set voltages on the data terminal portion 20A″ are voltages which are fractions of the voltage of the 5V power supply. The D terminal voltage control portion 14 can change terminal voltages on the D+ and D− terminals 20c and 20d of the data terminal portion 20A″ by using the mode selecting portion depending on the detected charging current. The mode selecting portion has an intermediate voltage mode and a short circuit mode as combinations of a plurality of terminal voltages. In addition, the mode selecting portion may have a non-monitoring mode dedicated for battery-driven devices which do not monitor terminal voltages on the data terminal portion 20A″.

For example, the D terminal voltage control portion 14 selects the intermediate voltage mode so that voltages on the D+ and D− terminals 20c and 20d are set to intermediate voltages if the output current value of the DC-DC converter 13 is not smaller than the predetermined first threshold current value. The D terminal voltage control portion 14 selects the short circuit mode so that voltages on the D+ and D− terminals 20c and 20d are short-circuited if the output current value of the DC-DC converter 13 is smaller than the predetermined first threshold current value. The D terminal voltage control portion 14 selects one mode from the terminal voltage selection modes based on data communication between the DC-DC converter 13 and the D terminal voltage control portion 14. The data communication is controlled by the power supply control circuit 12.

The power supply control circuit 12 according to the first embodiment first determines whether the current value supplied from the DC-DC converter 13 is at least the first threshold current value (e.g., 80 mA) at the start of electric power supply. If this current value is not smaller than the first threshold current value, the battery pack 10 determines that the battery-driven device 50 of slate PC is connected to the battery pack 10, and can keep supplying a current required for the battery-driven device 50 up to 1 or 1.5 A as the maximum current. The battery-driven device 50 of slate PC will detect the intermediate voltage of the D+ and D− terminals 20c and 20d as predetermined voltages, and determines that the battery-driven device 50 is connected to a power supply device which can supply electric power required for the battery-driven device 50. Subsequently, the battery-driven device 50 starts charging the device-side rechargeable battery. Thus, the DC-DC converter 13 of the battery pack 10 can detect the charging current supplied to the battery-driven device 50. In addition, also if a device which does not monitor the data terminal portion 20A″ starts charging the device-side rechargeable battery with a current not smaller than the first threshold current value, the battery pack 10 can supply the current required for this device.

If the output current from the DC-DC converter 13 is smaller than the first threshold current value, the battery pack 10 selects the short circuit mode in which the mode selecting portion short-circuits the D+ and the D− terminals 20c and 20d of the data terminal portion 20A″. In this mode, the power supply control circuit 12 determines whether the current value supplied from the DC-DC converter 13 is at least the second threshold current value (e.g., 150 mA). If this current value is not smaller than the second threshold current value, the battery pack 10 determines that the battery-driven devices 60 such as mobile phone and smart phone is connected to the battery pack 10, and can keep supplying a current required for the battery-driven device 60. In this case, the battery pack can keep supplying a current required for this battery-driven device up to 1 A as the maximum current. In addition, also if a device which does not monitor the data terminal portion 20A″ starts charging the device-side rechargeable battery with a current not smaller than the second threshold current value, the battery pack 10 can supply the current required for this device.

The battery-driven device 60 will detect the short circuit between the D+ and D− terminals 20c and 20d, and determines that the battery-driven device 60 is connected to a power supply device which can supply electric power required for the battery-driven device 60. Subsequently, the battery-driven device 60 starts charging the device-side rechargeable battery. Thus, the DC-DC converter 13 of the battery pack 10 can detect the charging current supplied to the battery-driven device 60.

If the detected current is smaller than the second threshold current value, the battery pack 10 determines that the battery-driven device 70 as low capacitive load driving mobile device is connected to a power supply device which can supply electric power required for the battery-driven device 70. Subsequently, the battery pack 10 can keep supplying a current required for the battery-driven device 70 up to 500 mA as the maximum current.

After recognizing that the battery pack 10 is connected to the battery-driven device 50 of slate PC or the battery-driven devices 60 such as mobile phone, the battery pack 10 can stop supplying the current if the output current is smaller than the third threshold current value. After recognizing that the battery pack 10 is connected to the battery-driven device 70 as low capacitive load driving mobile device, the battery pack 10 can stop supplying the current if the output current is smaller than the fourth threshold current value. Thus, the battery pack 10 can detect that a battery-driven device connected to the battery pack 10 is fully-charged, and can prevent that this battery-driven device is over-charged. Therefore, it is possible to ensure the safety of the battery-driven device.

### (Rechargeable Battery Cell 11)

Two rechargeable battery cells 11 as power source of the battery pack 10 are connected to each other in parallel. A large amount of output current from the rechargeable battery cells 11 is controlled by the power supply control circuit 12. Accordingly, the battery pack 10 can supply electric power required for the battery-driven device 50, 60, or 70. Although the battery pack according to the first embodiment includes two rechargeable battery cells, the number of rechargeable battery cells is not limited to this. The battery pack can include one battery cell, or three or more battery cells.

Cylindrical rechargeable lithium-ion batteries are used as the rechargeable battery cells. The rechargeable lithium-ion batteries can be cylindrical 18650 batteries, which are used as various types of power sources in laptop microcomputer, for example.

Since the rechargeable battery cells in this embodiment are rechargeable lithium-ion batteries having a large energy density, the battery pack has a small entire weight. Accordingly, the battery can be convenient to charge battery-driven devices. However, the rechargeable battery cells are not limited to rechargeable lithium-ion batteries. Any cylindrical rechargeable batteries can be used such as lithium-polymer batteries, nickel metal hydride batteries, and nickel-cadmium batteries.

### (Switching Circuit 17)

The power supply control circuit 12 operates based on ON/OFF of the switch 15, and controls the output from the rechargeable battery cell 11, in other words, electric power supply. The switch 15 is turned ON/OFF by the switching circuit 17. Users can press the press-button switch 21, which in turn actuates this switching circuit so that the battery pack starts supplying electric power to the battery-driven device 50, 60 or 70. When the press-button switch 21 is pressed by users, the switching circuit 17 is actuated so that the switch 15 can be turned ON. Thus, electric power of the rechargeable battery cell 11 is provided through the power supply control circuit 12, and can be supplied to the battery-driven device 50, 60 or 70 through the USB slot 20A as the output connector 20 for supplying electric power. In order to supply electric power, the USB slot 20A is connected to the USB input slot 51, 61 or 71 of the battery-driven device 50, 60 or 70.

### (Remaining Capacity Detecting Circuit 18)

In the battery pack 10, the remaining capacity detecting circuit 18 detects the remaining capacity of the rechargeable battery cells 11. If the remaining capacity is too small, the remaining capacity detecting circuit 18 turns the switch 15 OFF by controlling the switching circuit 17, stops supplying electric power. Accordingly, it is possible to prevent that the rechargeable battery cells 11 are over-discharged. Therefore, it is possible to protect the rechargeable battery cells.

### (Charge Control Circuit 16)

The rechargeable battery cell 11 of the battery pack 10 is supplied with electric power from external power supplies which is supplied to through the power receiving connector portion 23. The electric power is controlled by the charge control circuit 16 so that the rechargeable battery cells 11 are charged with the controlled electric power. This charge control circuit 16 charges the rechargeable battery cell 11 with monitoring the voltage, charging current, battery temperature, and the like of the rechargeable battery cells 11. The battery pack 10 includes the LED 22, which indicates charge and power supply statuses. For example, when the rechargeable battery cell 11 is charged, the LED 22 can flash periodically at a shorter period under the control of the remaining capacity detecting circuit 18. If the rechargeable battery cell 11 is fully charged, the LED 22 can stay ON. In addition, when electric power is supplied to the battery-driven device, the LED 22 can flash periodically at a longer period. Depending on the type of LED, the LED can emit orange light when the rechargeable battery cell 11 is charged, and can emit green light if the rechargeable battery cell 11 is fully charged. In addition, this LED can emit red light when electric power is supplied to the battery-driven device. In this case, users can know the status of the battery pack based on the color of LED light.

FIGS. 6 and 7 are the perspective views showing the external shape of the battery pack 10. FIG. 6 is the perspective view showing the external shape of the battery pack according to the first embodiment as viewed from the output connector side. The battery pack 10 includes an exterior case portion 40 of upper and lower exterior cases 40A and 40B. An operation portion 42 of the switch 15 is exposed from the upper surface of the exterior case 40A through a switch window 41. According to the construction, when the users operate the operation portion 42 of the switch 15, the battery pack 10 can start supplying electric power to the battery-driven device.

The battery pack includes a display portion 43 through which users can see the flashing or light color of the LED 22. According to this construction, users can know the charge status of the internal rechargeable battery cells 11 of the battery pack 10, and the power supply status of the battery-driven device based on the flashing or light color of the LED 22.

Connector windows 44A and 44B are opened on the left side surface in FIG. 6. The two USB slots 20A as the output connectors 20 are exposed through the connector windows 44A and 44B. When the output terminal 20 is connected to the USB input connector as the power receiving terminal of the battery-driven device, the battery pack 10 can supply electric power to the battery-driven device.

FIG. 7 is the perspective view showing the external shape of the battery pack according to the first embodiment as viewed from the power receiving connector portion side. The battery pack includes a DC input connector 23A and a USB input connector 23B which are arranged on the right side surface in FIG. 7, and are included the power receiving connector portion 23 to be connected to external power supplies. After commercial power is converted into direct-current electric power, the converted electric power is provided through the power receiving connector portion 23. Thus, the battery pack 10 can charge the internal rechargeable battery cells 11.

FIG. 8 is the exploded perspective view showing the battery pack 10 as viewed from the power supplying connector side. A battery assembly 25 is accommodated in the central part of the battery pack 10 as shown in FIG. 8. The battery assembly 25 includes the rechargeable battery cells 11, and an electrically-insulating circuit-board holder 24, which holds the circuit board 19. The circuit board 19 includes the press-button switch 21, the LED 22, and the other circuits (not shown). The DC input connector 23A and the USB input connector 23B are arranged on the right side surface in FIG. 8, and are included the power receiving connector portion 23 for receiving direct-current power converted from commercial power. The operation portion 42 is arranged above the press-button switch 21. The upper and lower sides of the battery assembly 25 are interposed between the upper and lower exterior cases 40A and 40B of the exterior case 40 in the battery pack 10. The upper and lower exterior cases 40A and 40B are fastened to each other by a screw 45 which is inserted from the lower side. Thus, the battery pack 10 can be unitarily assembled. Accordingly, the battery pack 10 can be conveniently used as a mobile standby power supply device capable of supplying electric power to various types of the battery-driven devices.

### Second Embodiment

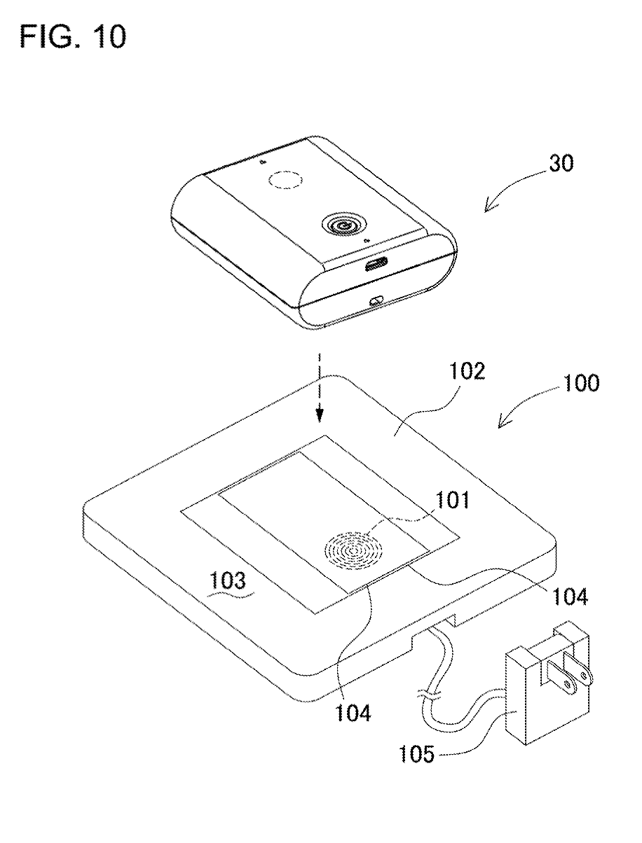

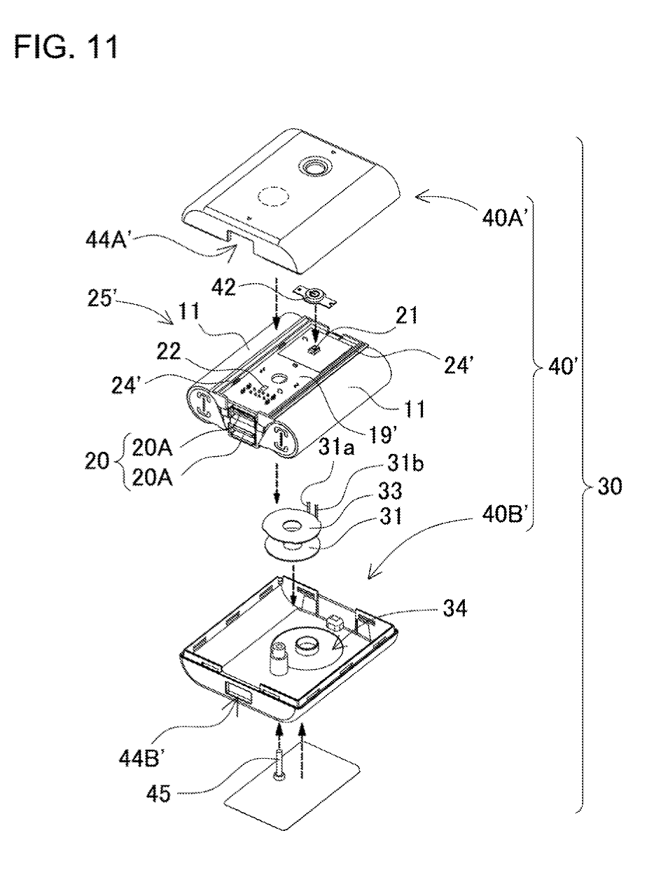

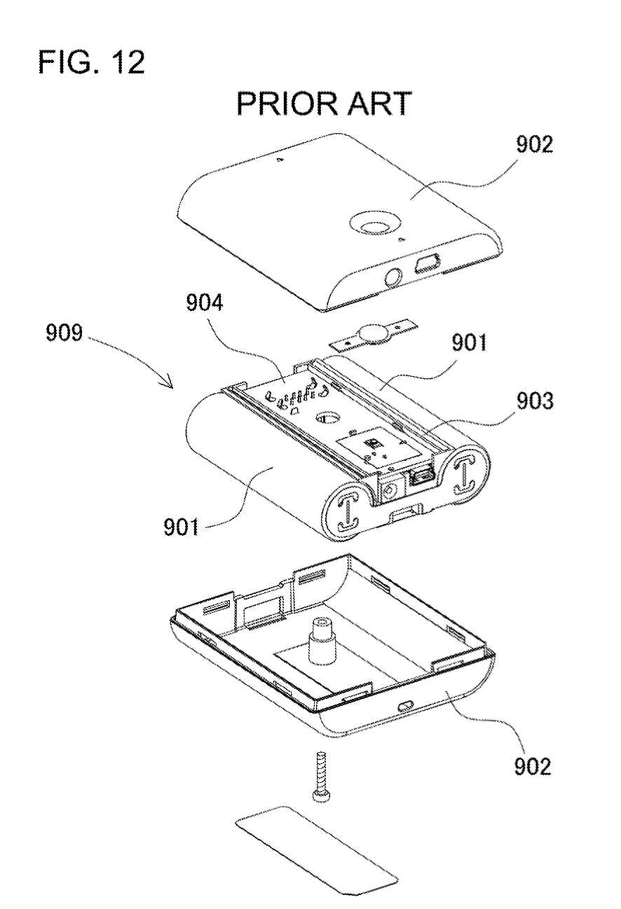

It has been illustratively described that the rechargeable battery cells of the battery pack according to the foregoing embodiment are charged through contacts from the external power supply. However, the present invention is not limited to this. The rechargeable battery cells of the battery pack can be charged in a non-contact charging manner. The following description will describe a battery pack according to a second embodiment which includes rechargeable battery cells to be charged in a non-contact charging manner with reference to FIGS. 9 to 11. FIG. 9 is a block diagram showing the battery pack according to a second embodiment. FIG. 10 is a perspective view showing the battery pack according to the second embodiment placed onto a non-contact charger. FIG. 11 is an exploded perspective view showing the battery pack according to the second embodiment.

FIG. 9 is the circuit block diagram showing a battery pack 30 according to the second embodiment, the battery-driven device 50, 60 or 70 connected to be each other. The battery pack 30 according to this second embodiment includes an energized coil 31, and a capacitor 32 serially connected to the energized coil 31 in addition to the battery pack 10 according to the first embodiment. The energized coil 31 can charge the battery cells in a non-contact charging manner. A charge control circuit 36 is provided instead of the charge control circuit 16, and converts induced electric power, which is provided through the capacitor 32 and the energized coil 31, into direct-current electric power. The battery pack 30 can supply electric power similarly to the operation of the battery pack 10 according to the first embodiment. The battery pack 30 according to the second embodiment includes a circuit board 19′ which includes the power supply control circuit 12, the switch 15, the switching circuit 17, and the remaining capacity detecting circuit 18 integrally mounted on the circuit board 19′ similar to the battery pack 10 according to the first embodiment. However, the circuit board 19′ additionally includes the charge control circuit 36 and the series capacitor 32 integrally mounted on the circuit board 19′ dissimilar to the battery pack 10 according to the first embodiment. According to this construction, the rechargeable battery cells 11 can be charged in a non-contact charging manner in addition to a contact charging manner in which direct-current electric power is provided from commercial power.

FIG. 10 is the perspective view showing the battery pack according to the second embodiment placed onto a non-contact charger. When the battery pack 30 including the energized coil 31 is placed on a non-contact charger 100, induced electric power is provided so that the internal rechargeable battery cells 11 can be charged. The non-contact charging base 100 is provided with electric power through an AC adaptor 105 which converts commercial power into direct-current electric power, and produces magnetic flux from the energizing coil 101 which is accommodated in the non-contact charging base 100. The charging base 100 is electrically insulated by a casing 102 which has a mount plate 103. When the battery pack 30 is placed on a marked portion 104 which indicates the place of the mount plate 103 where the battery pack 30 is required to be placed, electric power will be provided to the battery pack 30.

FIG. 11 is the exploded perspective view showing the battery pack 30 as viewed from the output connector side. The battery pack 30 includes an exterior case portion 40′ of upper and lower exterior cases 40A′ and 40B′. A battery assembly 25′ is accommodated in the battery pack 30 as shown in FIG. 8. The battery assembly 25′ includes the rechargeable battery cells 11, and an electrically-insulating circuit-board holder 24′, which holds the circuit board 19′. The circuit board 19′ includes the press-button switch 21, the LED 22, and the other circuits (not shown). The two USB slots 20A as the output connectors 20 are arranged on the left side in FIG. 11. The operation portion 42 is arranged above the press-button switch 21.

The battery pack 30 includes the energized coil 31 and a shield plate 33, which are shown in the lower central part in FIG. 11. The energized coil 31 includes center and outer leads 31a and 31b. The center lead 31a is drawn from the center of the energized coil 31. The center and outer leads 31a and 31b of this coil are electrically connected to the aforementioned circuit board 19′. The energized coil 31 and the shield plate 33 are arranged in a coil mounting portion 34 which is arranged in the lower exterior case 40B′. The energized coil 31 and the shield plate 33 are fastened to the lower exterior case 40B′. The upper exterior case 40A′ is placed onto the upper part of the battery assembly 25′, which includes the circuit board 19′. Thus, the battery assembly 25′ is interposed between the upper and lower exterior cases 40A′ and 40B′. The upper and lower exterior cases 40A′ and 40B′ are fastened to each other by the screw 45 which is inserted from the lower side. After the battery pack 30 is unitarily assembled, the two USB slots 20A as the output connectors 20 are exposed through connector windows 44A′ and 44B′. The battery pack 30 can be used as a power supply device which can supply electric power to various types of battery-driven devices through USB connection. Since this battery pack 30 can be charged in a non-contact charging manner, the battery pack 30 can be held fully changed by only placing the battery pack 30 on the charging base 100 without using connection cable or the like. Accordingly, the battery pack 30 can be conveniently used as a standby power supply device.

### INDUSTRIAL APPLICABILITY

A battery pack including an output connector, a battery-pack-and-battery-driven-device system, and a charging method according to the present invention can be suitably used as or for a battery pack which includes an output connector connectable to the battery-driven devices such as slate PC, smart phone, and portable recorder which can be charged through USB connection.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2011-187,935 filed in Japan on Aug. 30, 2011, the content of which is incorporated herein by reference.

What is claimed is:

1. A battery pack comprising:
an output connector which can be connected to a battery-driven device, and supply electric power to a device-side rechargeable battery included in this battery-driven device;
a rechargeable battery cell; and
a power supply control circuit which converts a voltage from said rechargeable battery cell into an output voltage,
wherein the output voltage converted by said power supply control circuit can be provided through said output connector,
wherein said output connector includes a power supply terminal portion and a data terminal portion,
wherein a current required for the battery-driven device connected to said output connector can be supplied through said power supply terminal portion,
wherein a terminal voltage on the data terminal portion can be switched between different voltages based on a current which is drawn by the battery-driven device through said power supply terminal portion.

2. The output connector equipped battery pack according to claim 1,
wherein said power supply control circuit can select from among terminal voltage selection modes for setting a terminal voltage on said data terminal portion based on the charging current,
wherein the terminal voltage selection modes include
an intermediate voltage mode in which predetermined voltages are applied to D+ and D− terminals as said data terminal portion, and
a short circuit mode in which said D+ and D− terminals are short-circuited.

3. The output connector equipped battery pack according to claim 2, wherein the terminal voltage selection modes of said power supply control circuit further includes a non-monitoring mode in which electric power is supplied to the battery-driven device without monitoring the voltage of said data terminal portion.

4. The output connector equipped battery pack according to claim 2,
wherein said intermediate voltage mode is a terminal voltage selection mode for slate PC,
wherein said short circuit mode is a terminal voltage selection mode for smart phone.

5. The output connector equipped battery pack according to claim 2,
wherein in the intermediate voltage mode, said power supply control circuit
holds the intermediate voltage mode and selects a first current mode if the charging current drawn by the battery-driven device is not lower than a predetermined first threshold current, the first current mode limiting the charging current drawn through said power supply terminal portion to a predetermined first upper limit current value, and
switches the voltage of said data terminal portion from the intermediate voltage mode to the short circuit mode if the detected charging current is kept lower than the first threshold current value for a predetermined time period.

6. The output connector equipped battery pack according to claim 5,
wherein in the short circuit mode, said power supply control circuit
holds the short circuit mode and selects a second current mode if the charging current drawn by the battery-driven device is not lower than a predetermined second threshold current, the second current mode limiting the charging current drawn through said power supply terminal portion to a predetermined second upper limit current value smaller than the predetermined first upper limit current value, and
switches from the short circuit mode to the non-monitoring mode and selects a third current mode if the detected charging current is kept lower than the second threshold current value for a predetermined time period, the third current mode limiting the charging current drawn through said power supply terminal portion to a predetermined third upper limit current value smaller than the predetermined second upper limit current value.

7. The output connector equipped battery pack according to claim 5, wherein in the first or second current mode, said power supply control circuit stops supplying electric power through said power supply terminal portion if the charging current is kept lower than a predetermined third threshold current lower than the first and second threshold currents for a predetermined time period.

8. The output connector equipped battery pack according to claim 6, wherein in the third current mode, said power supply control circuit stops supplying electric power through said power supply terminal portion if the charging current is kept lower than a fourth predetermined threshold current lower than the third threshold current for a predetermined time period.

9. The output connector equipped battery pack according to claim 1, wherein said output connector has the same terminal shape as the USB standards.

10. The output connector equipped battery pack according to claim 1, wherein said battery pack serves as a portable power supply device.

11. The output connector equipped battery pack according to claim 1 further comprising
an energized coil which can receive electric power from an energizing coil when the battery pack is placed on a charging base, the charging base including the energizing coil for transmitting the electric power by electromagnetic induction whereby charging said rechargeable battery cell, and
a charge control circuit which charges said rechargeable battery cell with the electric power which is induced in said energized coil,
wherein said rechargeable battery cell can be charged with the electric power which is induced in said energized coil by the energizing coil when the battery pack is placed on a charging base.

12. A battery-pack-and-battery-driven-device system comprising:
a battery-driven device; and
a battery pack which can be connected to said battery-driven device and can supply electric power to said battery-driven device,
wherein said battery-driven device includes
a device-side rechargeable battery,
an input connector through which the electric power supply can be supplied, and
a device charge control circuit which determines whether the battery pack can supply electric power to said device-side rechargeable battery whereby charging said device-side rechargeable battery after the battery pack is connected to said input connector, the device charge control circuit controlling the electric power, which is supplied from this battery pack, whereby charging said device-side rechargeable battery if determining that the battery pack can supply electric power,
wherein said battery pack includes
a rechargeable battery cell,
a power supply control circuit which adjusts electric power depending on said battery-driven device, and
an output connector through which the adjusted electric power is supplied,
wherein said output connector includes a power supply terminal portion and a data terminal portion,
wherein said power supply control circuit can change a voltage on said data terminal portion to different voltages, and said power supply control circuit has a plurality of terminal voltage selection modes which correspond to the different voltages for said data terminal portion,
wherein said power supply control circuit selects from among the terminal voltage selection modes based on the charging current which is drawn by the battery-driven device, which is connected through said input connector to said output connector.

13. A charging method for charging a device-side rechargeable battery included in a battery-driven device by using a battery pack which can be connected to the battery-driven device, the method comprising:
connecting the battery-driven device to an output connector of said battery pack;
allowing the battery-driven device to start drawing current required for the battery-driven device from a rechargeable battery cell included in said battery pack through a power supply terminal portion included in said output connector;
detecting this current by a power supply control circuit included in said battery pack; and
switching the voltage of a data terminal portion included in said output connector between predetermined voltages by said power supply control circuit based on the value of the current, which is detected by said power supply control circuit, by referring a predetermined relationship between current value and terminal voltage.

14. The charging method for charging a device-side rechargeable battery by using a battery pack according to claim 13,
wherein said data terminal portion includes D+ and D− terminals,
wherein in said relationship between current value and terminal voltage, said power supply control circuit sets voltages on said D+ and D− terminals to predetermined voltages if the detected current is not smaller than a first threshold current value, and said power supply control circuit short-circuits said D+ and D− terminals if the detected current is smaller than the first threshold current value.

15. The charging method for charging a device-side rechargeable battery by using a battery pack according to claim 14,
wherein said power supply control circuit selects from among modes for setting a terminal voltage on said data terminal portion based on the current value,
wherein the modes include
an intermediate voltage mode in which predetermined voltages are applied to said D+ and D− terminals as said data terminal portion, and
a short circuit mode in which said D+ and D− terminals are short-circuited.
